(19) United States
(12) Patent Application Publication
(10) Pub. No.: US 2010/0106957 A1
(43) Pub. Date: Apr. 29, 2010

(54) PROGRAMMING AND CONFIGURATION IN A HEATING, VENTILATION AND AIR CONDITIONING NETWORK

(75) Inventors: Wojciech Grohman, Little Elm, TX (US); Jacob Jennings, Irving, TX (US); Amanda Filbeck, Guthrie, TX (US)

Correspondence Address: HITT GAINES P.C., P.O. BOX 832570, RICHARDSON, TX, 75083, US

(73) Assignee: Lennox Industries Inc., Richardson, TX (US)

(21) Appl. No.: 12/603,468

(22) Filed: Oct. 21, 2009

Related U.S. Application Data
(63) Continuation-in-part of application No. 12/258,659, filed on Oct. 27, 2008.
(60) Provisional application No. 61/167,135, filed on Apr. 6, 2009.

(51) Int. Cl. G06F 9/24; G06F 12/14; G05D 23/19

(52) U.S. Cl. 713/2; 711/103; 711/163; 711/E12.091; 700/276

(57) ABSTRACT

Various embodiments of systems and methods of creating a memory of an HVAC device. A bootloader code is stored into a first protected memory of the HVAC device. A device designator is stored into a second protected memory of the HVAC device. A control serial number is stored into a third protected memory of the HVAC device. A control part number is stored into a fourth protected memory of the HVAC device. An application data is stored into a separate application memory of the HVAC device.

### CROSS-REFERENCE TO RELATED APPLICATIONS

This application claims the benefit of U.S. Provisional Application Ser. No. 61/167,135, filed by Grohman, et al., on Apr. 6, 2009, entitled “Comprehensive HVAC Control System”, and is a continuation-in-part application of application Ser. No. 12/258,659, filed by Grohman on Oct. 27, 2008, entitled “Apparatus and Method for Controlling an Environmental Conditioning Unit,” both of which are commonly assigned with this application and incorporated herein by reference. This application is also related to the following U.S. patent applications, which are filed on even date herewith, commonly assigned with this application and incorporated herein by reference:

| Serial No. | Inventors | Title |
|---|---|---|
| [Attorney | Grohman, | “Alarm and Diagnostics System and Method |
| Docket No. | et al. | for a Distributed-Architecture Heating, |
| 080161] | | Ventilation and Air Conditioning |
| | | Network” |
| [Attorney | Wallaert, | “Flush Wall Mount Control Unit and In- |
| Docket No. | et al. | Set Mounting Plate for a Heating, |
| 070064] | | Ventilation and Air Conditioning System” |
| [Attorney | Thorson, | “System and Method of Use for a User |
| Docket No. | et al. | Interface Dashboard of a Heating, |
| 070027] | | Ventilation and Air Conditioning |
| | | Network” |
| [Attorney | Grohman | “Device Abstraction System and Method |
| Docket No. | | for a Distributed-Architecture Heating, |
| 070016] | | Ventilation and Air Conditioning |
| | | Network” |
| [Attorney | Grohman, | “Communication Protocol System and |
| Docket No. | et al. | Method for a Distributed-Architecture |
| 070079] | | Heating, Ventilation and Air |
| | | Conditioning Network” |
| [Attorney | Hadzidedic | “Memory Recovery Scheme and Data |
| Docket No. | | Structure in a Heating, Ventilation and |
| 080151] | | Air Conditioning Network” |
| [Attorney | Grohman | “System Recovery in a Heating, |
| Docket No. | | Ventilation and Air Conditioning |
| 080173] | | Network” |
| [Attorney | Grohman, | “System and Method for Zoning a |
| Docket No. | et al. | Distributed-Architecture Heating, |
| 080131] | | Ventilation and Air Conditioning |
| | | Network” |
| [Attorney | Grohman, | “Method of Controlling Equipment in a |
| Docket No. | et al. | Heating, Ventilation and Air |
| 080163] | | Conditioning Network” |
| [Attorney | Grohman, | “Programming and Configuration in a |
| Docket No. | et al. | Heating, Ventilation and Air |
| 080160] | | Conditioning Network” |
| [Attorney | Mirza, | “General Control Techniques in a |
| Docket No. | et al. | Heating, Ventilation and Air |
| 080146] | | Conditioning Network” |

### TECHNICAL FIELD

This application is directed, in general, to distributed-architecture heating, ventilation and air conditioning (HVAC) systems, more specifically, to a memory scheme, data recovery, and programming in an HVAC network.

### BACKGROUND

Climate control systems, also referred to as HVAC systems (the two terms will be used herein interchangeably), are employed to regulate the temperature, humidity and air quality of premises, such as a residence, office, store, warehouse, vehicle, trailer, or commercial or entertainment venue. The most basic climate control systems either move air (typically by means of an air handler or, or more colloquially, a fan or blower), heat air (typically by means of a furnace) or cool air (typically by means of a compressor-driven refrigerant loop). A thermostat is typically included in the climate control systems to provide some level of automatic temperature control. In its simplest form, a thermostat turns the climate control system on or off as a function of a detected temperature. In a more complex form, a thermostat may take other factors, such as humidity or time, into consideration. Still, however, the operation of a thermostat remains turning the climate control system on or off in an attempt to maintain the temperature of the premises as close as possible to a desired setpoint temperature. Climate control systems as described above have been in wide use since the middle of the twentieth century.

### SUMMARY

One aspect provides a method for creating a memory of an HVAC device. In an embodiment, the method comprises storing a bootloader into a first protected memory of the HVAC device; storing a device designator into a second protected memory of the HVAC device; storing a control serial number into a third protected memory of the HVAC device; storing a control part number into a fourth protected memory of the HVAC device, and storing an application data into a separate application memory of the HVAC device.

Another aspect provides a memory for use for flashing in an HVAC device, comprising: a protected bootloader area; a protected data memory area configured to contain protected data; a protected supplier data memory area configured to contain factory programmable features, and a separate application data page configured to contain protected application data, wherein said memory areas and said data page are contained within said HVAC device.

Yet another aspect provides a method for flashing a memory of a HVAC device. The method comprises flashing a code area by a supplier in an HVAC device, flashing a first data area by the supplier in the HVAC device, and flashing a second data area by an installer in the HVAC device.

### BRIEF DESCRIPTION

Reference is now made to the following descriptions taken in conjunction with the accompanying drawings, in which:

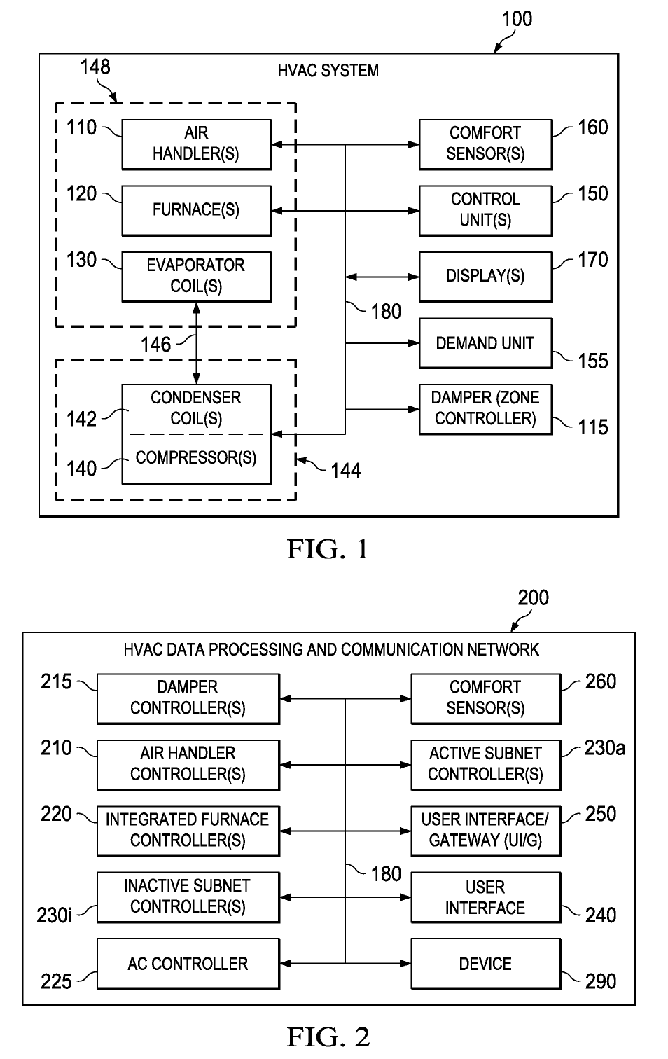

FIG. 1 is a high-level block diagram of an HVAC system within which a device abstraction system and method may be contained or carried out;

FIG. 2 is a high-level block diagram of one embodiment of an HVAC data processing and communication network 200;

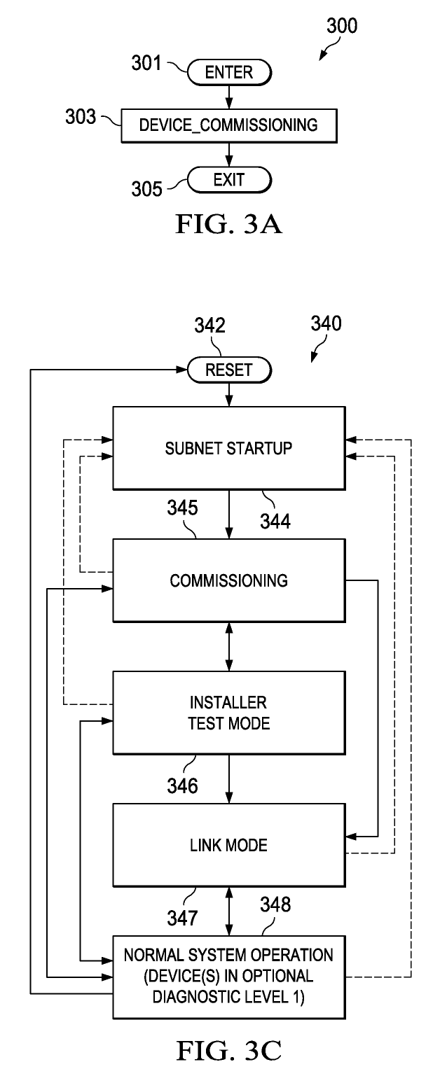

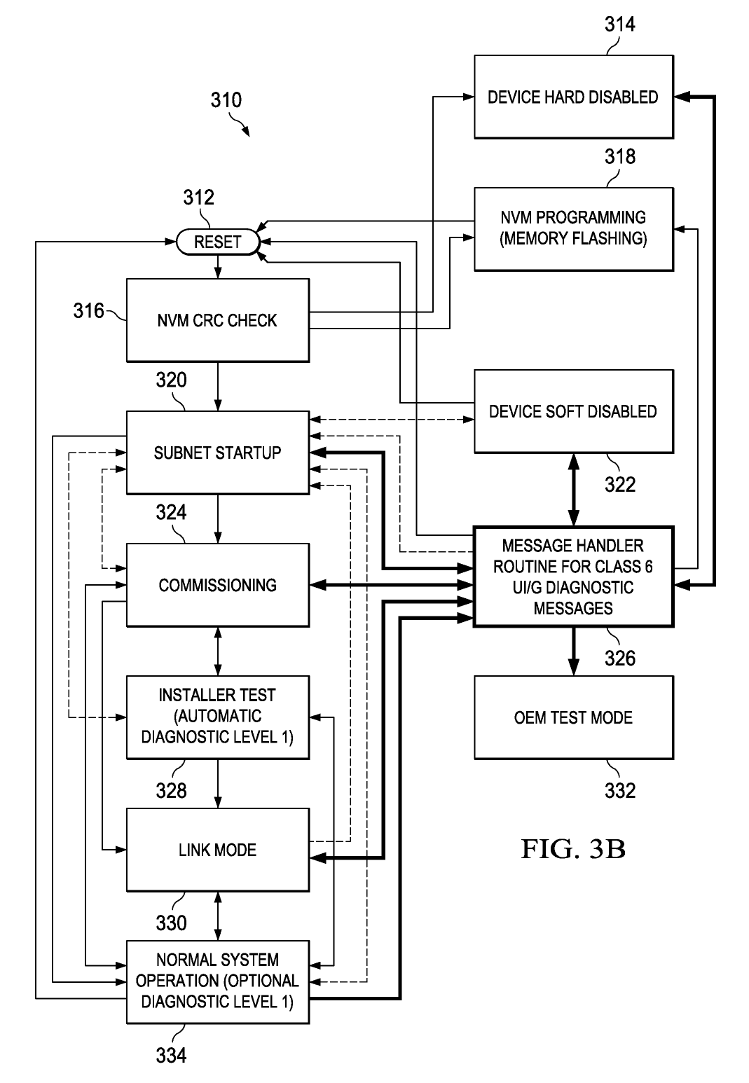

FIG. 3A is a diagram of a series of steps in an event sequence that depicts a device commissioning in an HVAC network having an active subnet controller;

FIG. 3B is a diagram of a series of steps that occur in relation to a commissioning of a subnet including an addressable unit;

FIG. 3C is a diagram of the above series of steps of FIG. 3B to be followed by a subnet controller to synchronize with a device of the HVAC system;

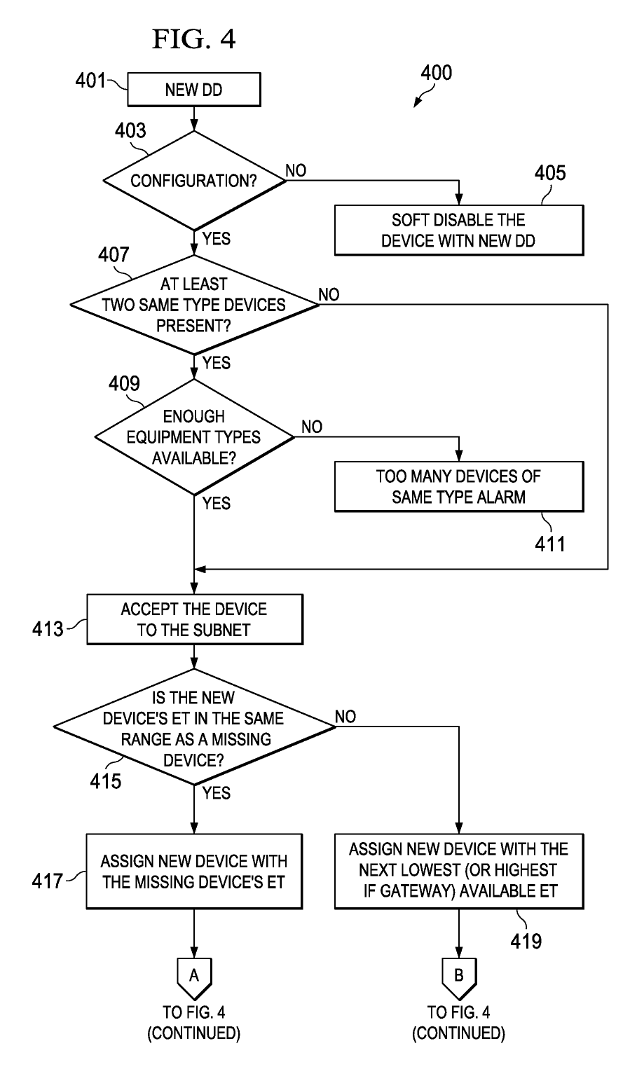

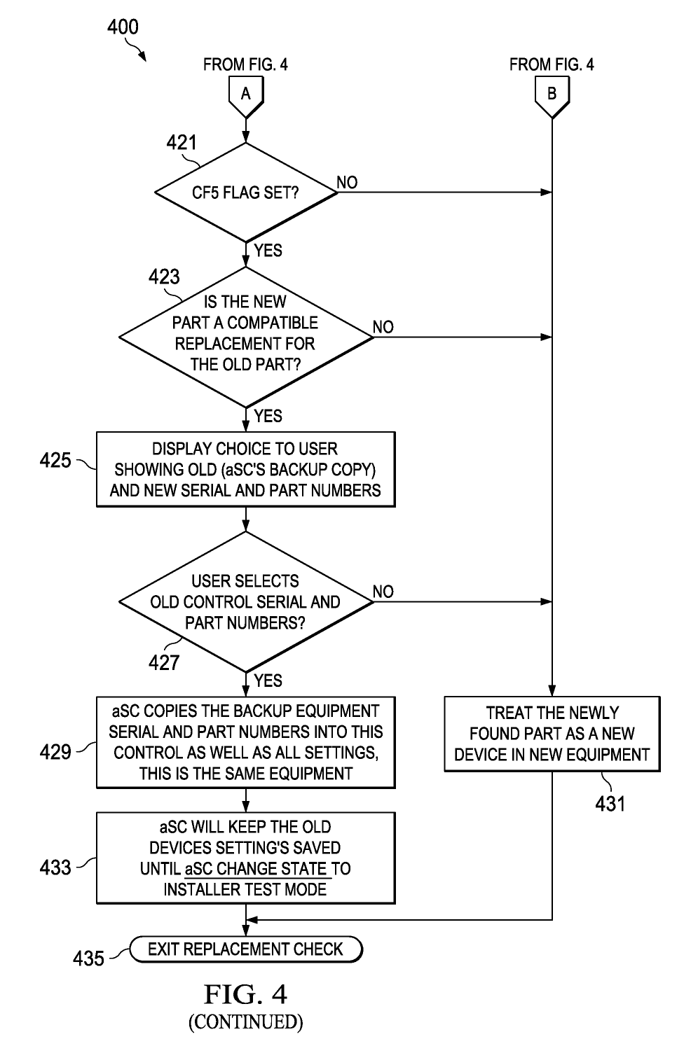

FIG. 4 illustrates an exemplary flow for device replacement and commissioning that can use back-up information;

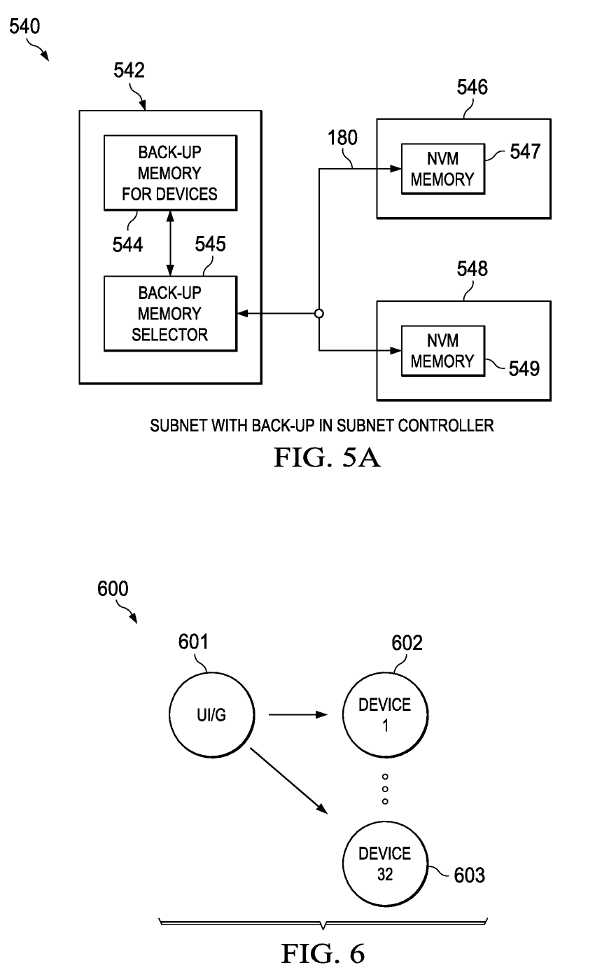

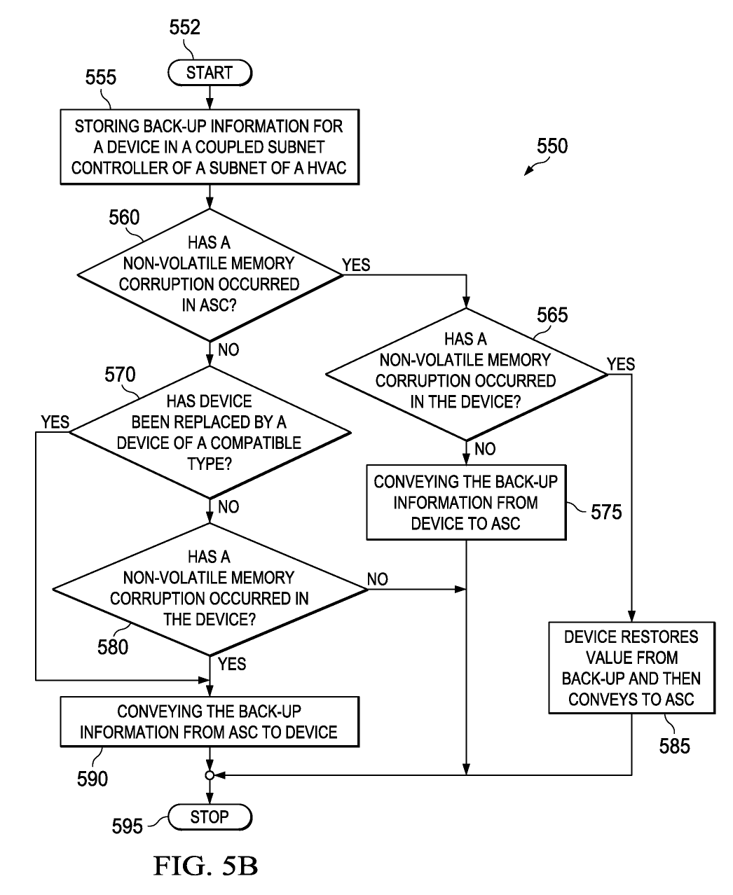

FIG. 5A is an illustration of an embodiment of a high level block diagram of a subnet with an information back-up in a subnet controller;

FIG. 5B illustrates an exemplary flow of a method of storing back-up information within a subnet controller;

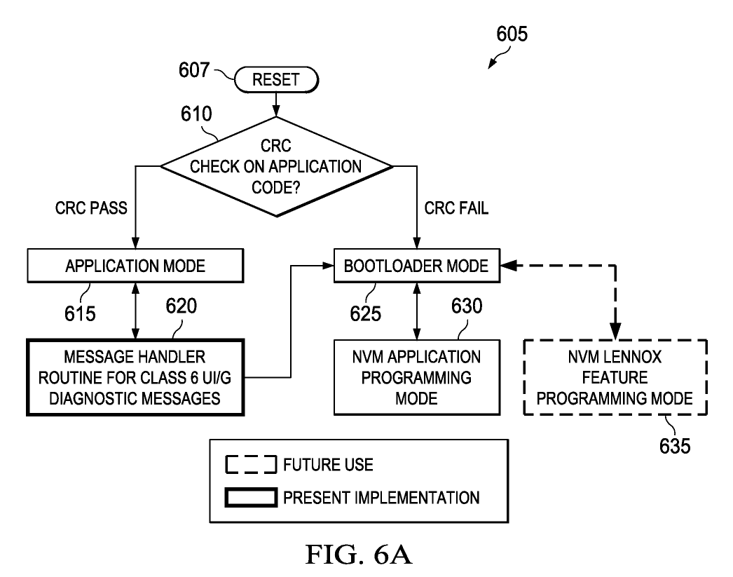

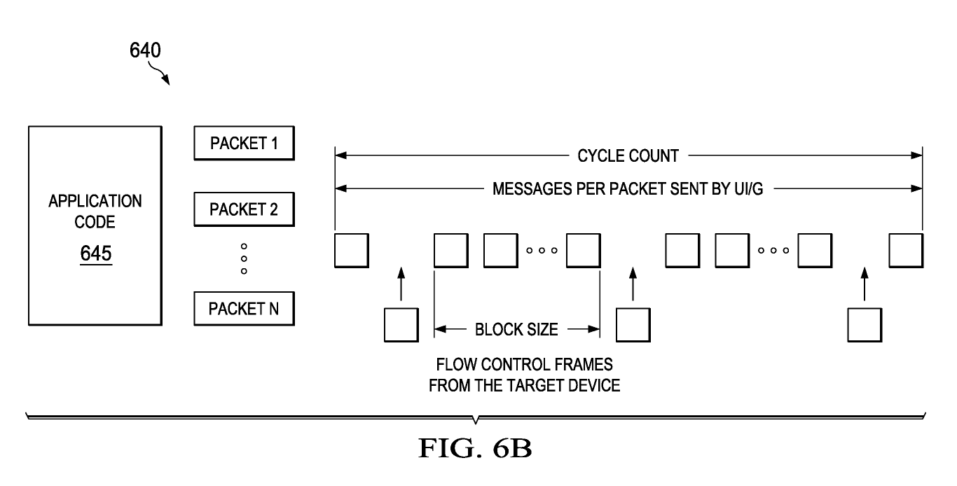

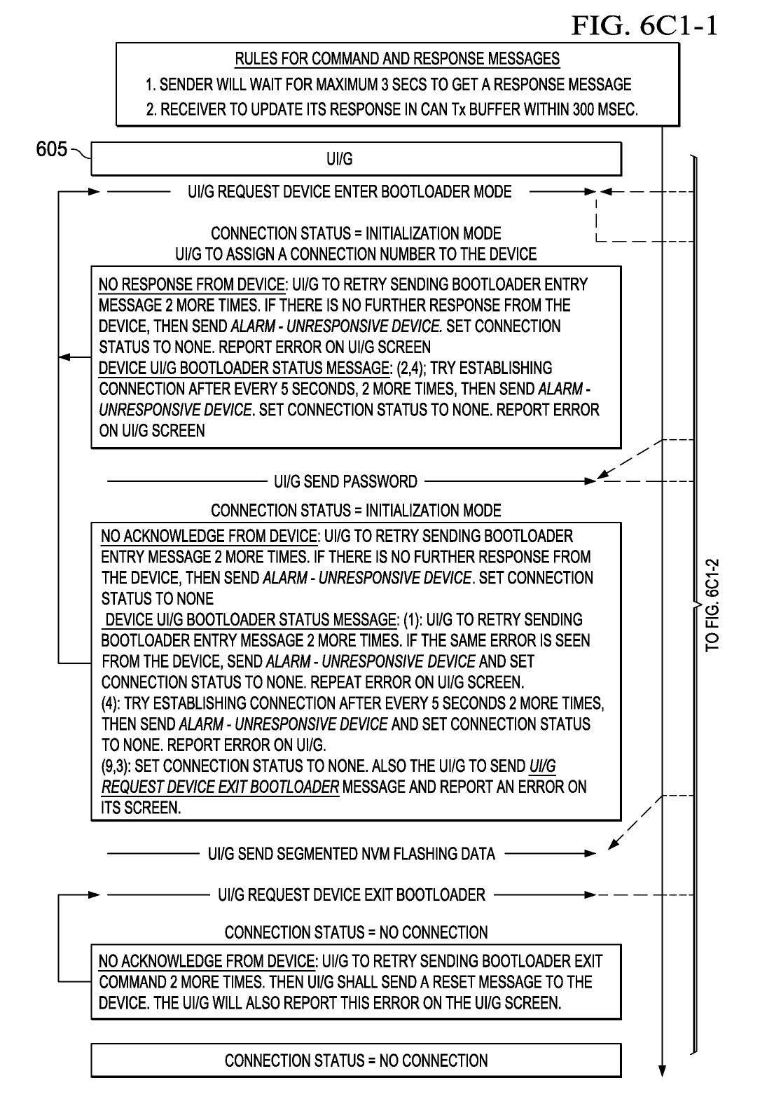

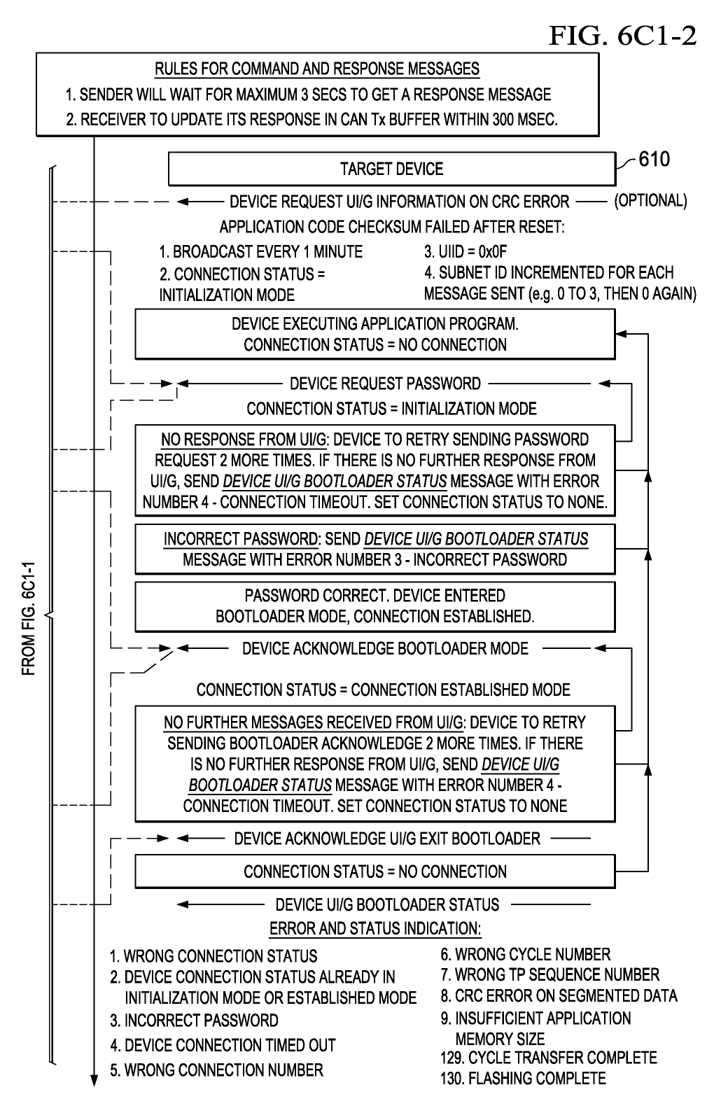

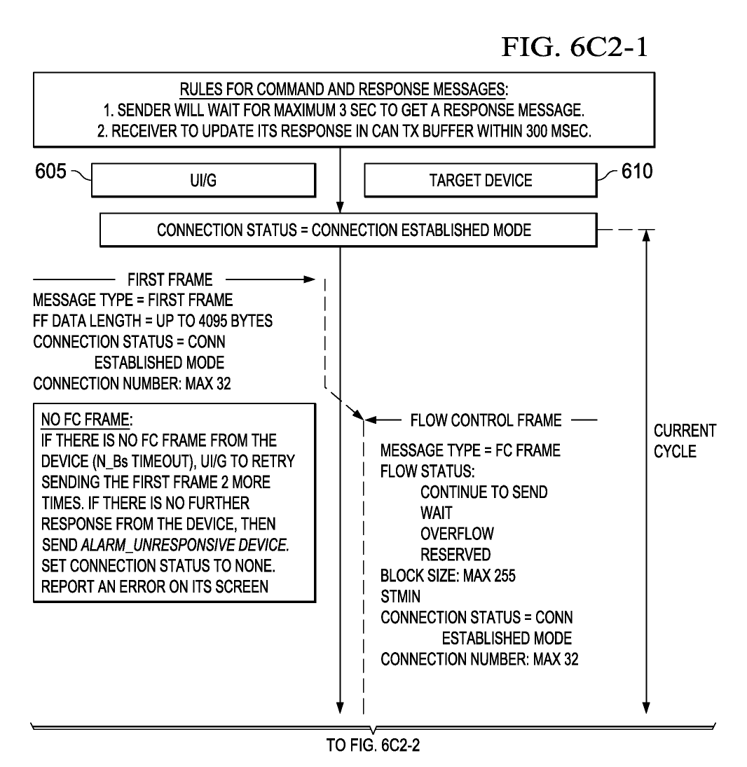

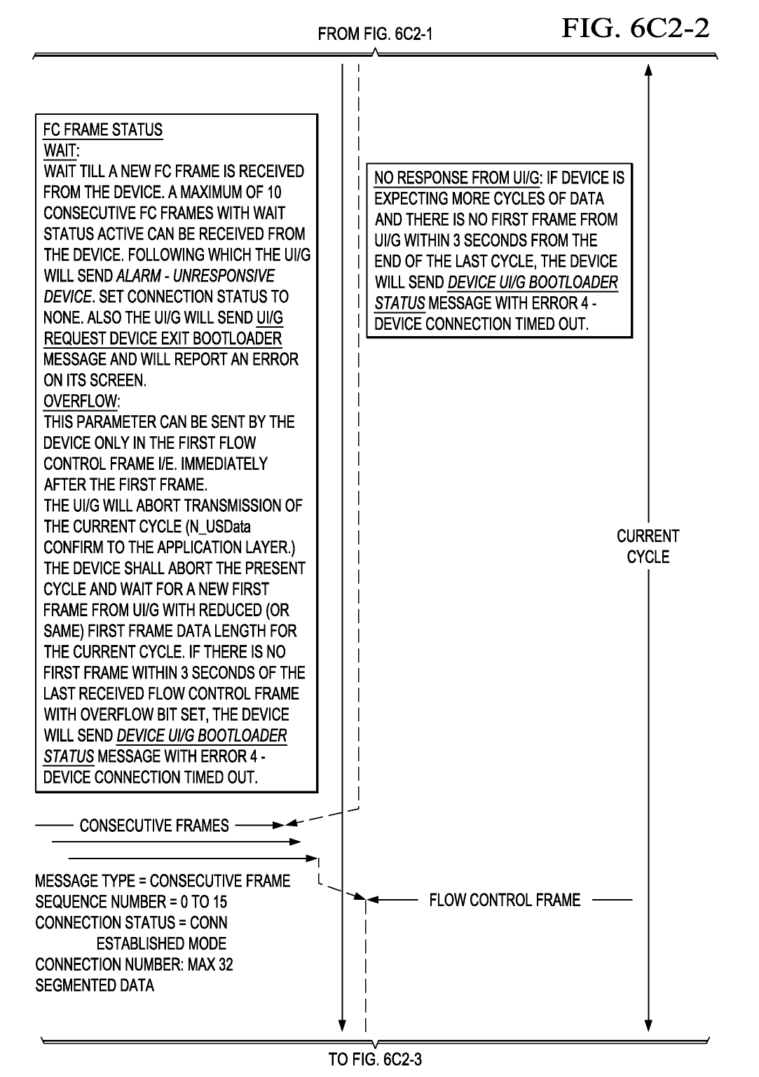

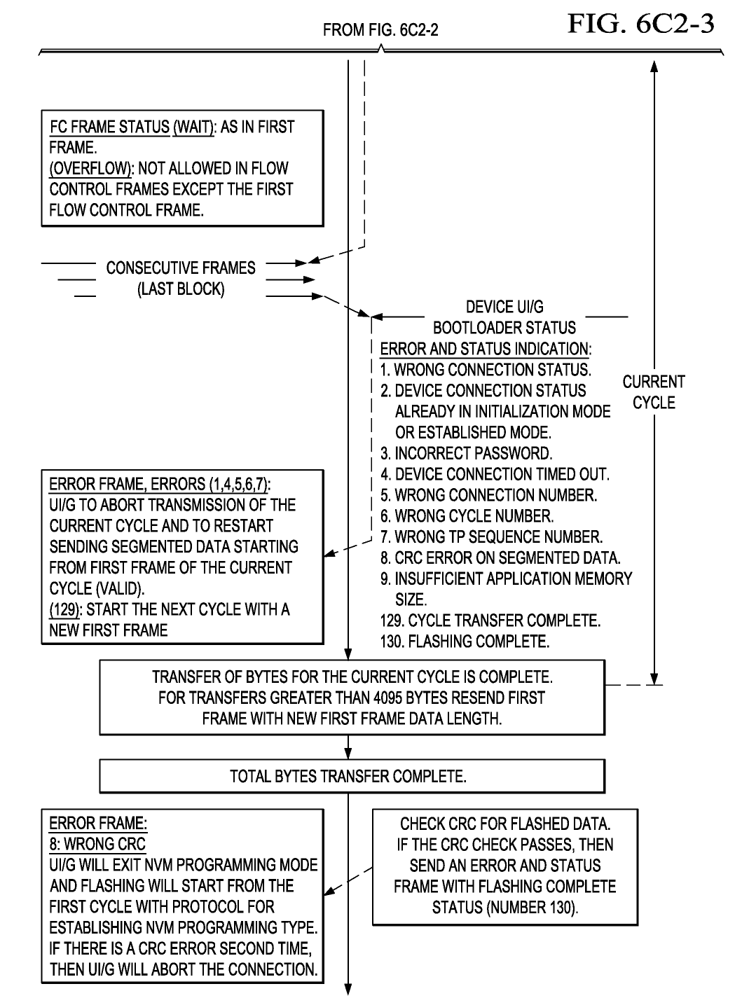

FIG. 6 illustrates an exemplary diagram wherein a plurality of devices can be flash programmed concurrently by a user interface/gateway of the HVAC network of FIG. 1;

FIG. 6A illustrates an exemplary flow of a method for programming a non-volatile memory in an HVAC device;

FIG. 6B illustrates a high-level block diagram of an embodiment of a data transfer between a device and a user interface/gateway;

FIGS. 6C1 and 6C2 illustrate a boot-loader device loading in an non-volatile memory (“NVM”);

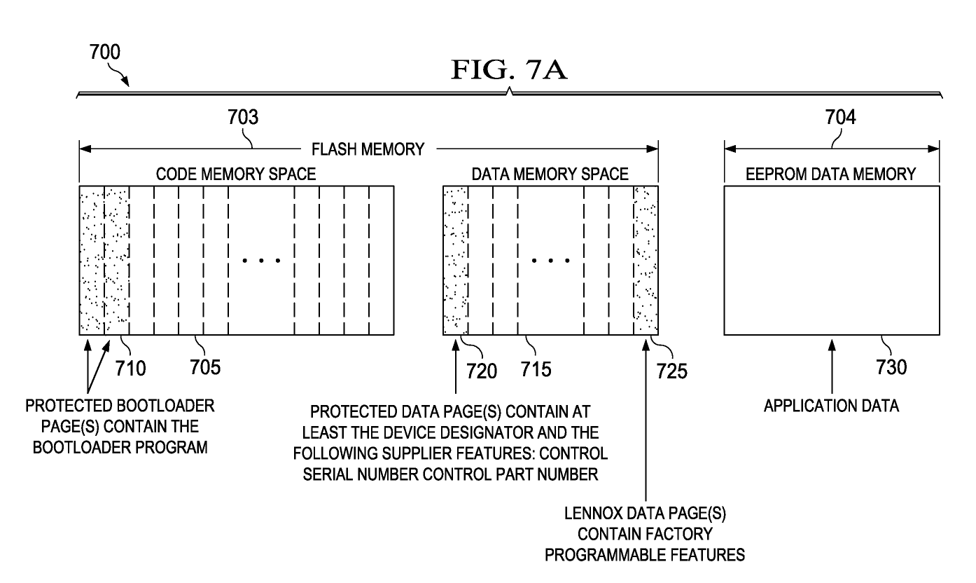

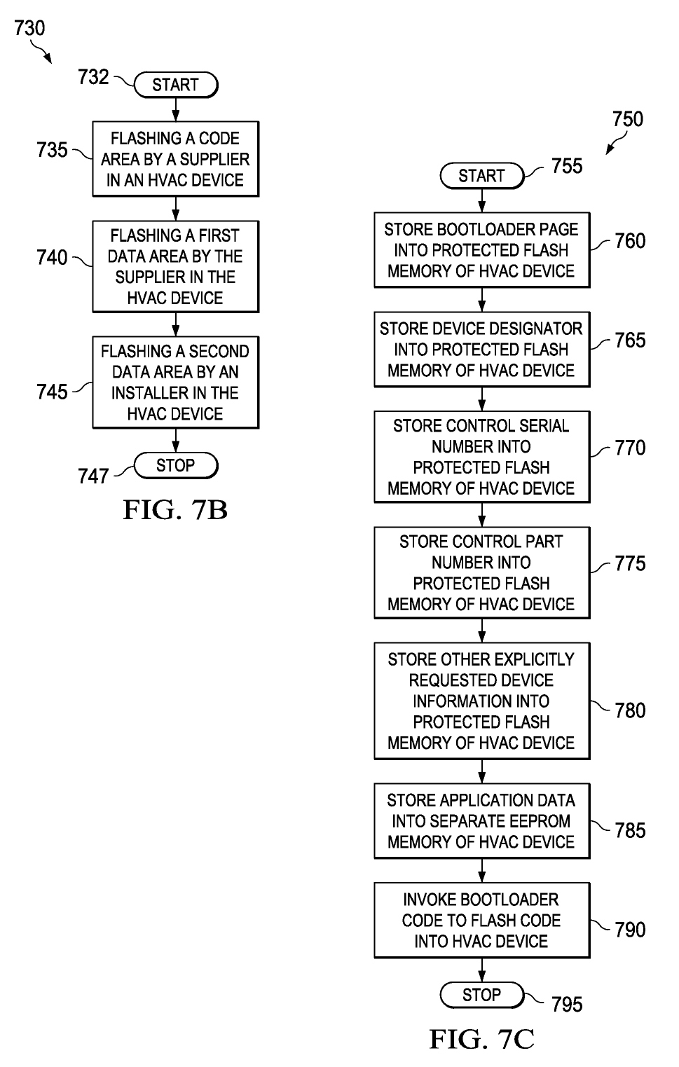

FIG. 7A illustrates one embodiment of a memory structure used in an HVAC device;

FIG. 7B illustrates an exemplary flow of a method to store memory into protected areas of an HVAC device;

FIG. 7C illustrates an exemplary embodiment of a flow of flash programming an HVAC device of FIG. 7B in more detail;

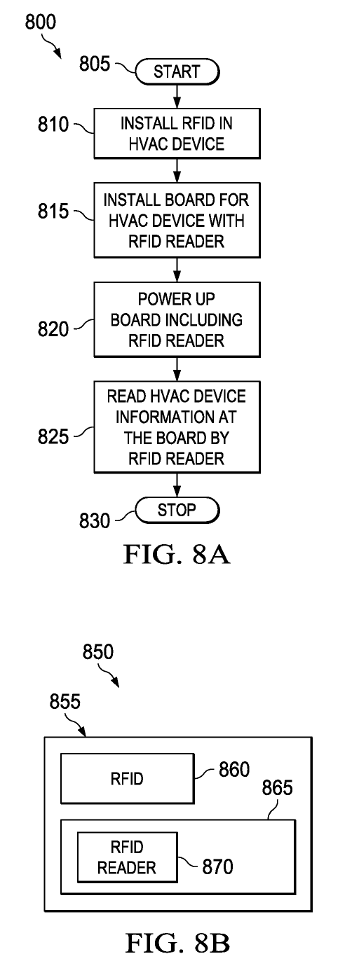

FIG. 8A illustrates an exemplary flow of a method for conveying information from an HVAC device to an RFID reader; and

FIG. 8B illustrates a high-level block diagram of an embodiment of a system for transmitting information from an HVAC device to an RFID reader coupled to a board installed within the HVAC device.

### DETAILED DESCRIPTION

As stated above, conventional climate control systems have been in wide use since the middle of the twentieth century and have, to date, generally provided adequate temperature management. However, it has been realized that more sophisticated control and data acquisition and processing techniques may be developed and employed to improve the installation, operation and maintenance of climate control systems.

Described herein are various embodiments of an improved climate control, or HVAC, system in which at least multiple components thereof communicate with one another via a data bus. The communication allows identity, capability, status and operational data to be shared among the components. In some embodiments, the communication also allows commands to be given. As a result, the climate control system may be more flexible in terms of the number of different premises in which it may be installed, may be easier for an installer to install and configure, may be easier for a user to operate, may provide superior temperature and/or relative humidity (RH) control, may be more energy efficient, may be easier to diagnose and perhaps able to repair itself, may require fewer, simpler repairs and may have a longer service life.

FIG. 1 is a high-level block diagram of an HVAC system, generally designated 100. The HVAC system may be referred to herein simply as “system 100” for brevity. In one embodiment, the system 100 is configured to provide ventilation and therefore includes one or more air handlers 110. In an alternative embodiment, the ventilation includes one or more dampers 115 to control air flow through air ducts (not shown.) Such control may be used in various embodiments in which the system 100 is a zoned system. In the context of a zoned system 100, the one or more dampers 115 may be referred to as zone controllers 115. In an alternative embodiment, the system 100 is configured to provide heating and therefore includes one or more furnaces 120, typically associated with the one or more air handlers 110. In an alternative embodiment, the system 100 is configured to provide cooling and therefore includes one or more refrigerant evaporator coils 130, typically associated with the one or more air handlers 110. Such embodiment of the system 100 also includes one or more compressors 140 and associated condenser coils 142, which are typically associated in one or more so-called “outdoor units” 144. The one or more compressors 140 and associated condenser coils 142 are typically connected to an associated evaporator coil 130 by a refrigerant line 146. In an alternative embodiment, the system 100 is configured to provide ventilation, heating and cooling, in which case the one or more air handlers 110, furnaces 120 and evaporator coils 130 are associated with one or more “indoor units” 148, e.g., basement or attic units.

For convenience in the following discussion, a demand unit 155 is representative of the various units exemplified by the air handler 110, furnace 120, and compressor 140, and more generally includes an HVAC component that provides a service in response to control by the control unit 150. The service may be, e.g., heating, cooling, or air circulation. The demand unit 155 may provide more than one service, and if so, one service may be a primary service, and another service may be an ancillary service. For example, for a cooling unit that also circulates air, the primary service may be cooling, and the ancillary service may be air circulation (e.g. by a blower).

The demand unit 155 may have a maximum service capacity associated therewith. For example, the furnace 120 may have a maximum heat output (often expressed in terms of British Thermal Units, or BTU), or a blower may have a maximum airflow capacity (often expressed in terms of cubic feet per minute, or CFM). In some cases, the addressable unit 155 may be configured to provide a primary or ancillary service in staged portions. For example, blower may have two or more motor speeds, with a CFM value associated with each motor speed.

One or more control units 150 control one or more of the one or more air handlers 110, the one or more furnaces 120 and/or the one or more compressors 140 to regulate the temperature of the premises, at least approximately. In various embodiments to be described, the one or more displays 170 provide additional functions such as operational, diagnostic and status message display and an attractive, visual interface that allows an installer, user or repairman to perform actions with respect to the system 100 more intuitively. Herein, the term “operator” will be used to refer collectively to any of the installer, the user and the repairman unless clarity is served by greater specificity.

One or more separate comfort sensors 160 may be associated with the one or more control units 150 and may also optionally be associated with one or more displays 170. The one or more comfort sensors 160 provide environmental data, e.g. temperature and/or humidity, to the one or more control units 150. An individual comfort sensor 160 may be physically located within a same enclosure or housing as the control unit 150. In such cases, the commonly housed comfort sensor 160 may be addressed independently. However, the one or more comfort sensors 160 may be located separately and physically remote from the one or more control units 150. Also, an individual control unit 150 may be physically located within a same enclosure or housing as a display 170. In such embodiments, the commonly housed control unit 150 and display 170 may each be addressed independently. However, one or more of the displays 170 may be located within the system 100 separately from and/or physically remote to the control units 150. The one or more displays 170 may include a screen such as a liquid crystal display (not shown).

Although not shown in FIG. 1, the HVAC system 100 may include one or more heat pumps in lieu of or in addition to the one or more furnaces 120, and one or more compressors 140. One or more humidifiers or dehumidifiers may be employed to increase or decrease humidity. One or more dampers may be used to modulate air flow through ducts (not shown). Air cleaners and lights may be used to reduce air pollution. Air quality sensors may be used to determine overall air quality.

Finally, a data bus 180, which in the illustrated embodiment is a serial bus, couples the one or more air handlers 110, the one or more furnaces 120, the one or more evaporator coils 130, the one or more condenser coils 142 and compressors 140, the one or more control units 150, the one or more remote comfort sensors 160 and the one or more displays 170 such that data may be communicated therebetween or thereamong. As will be understood, the data bus 180 may be advantageously employed to convey one or more alarm messages or one or more diagnostic messages.

FIG. 2 is a high-level block diagram of one embodiment of an HVAC data processing and communication network 200 that may be employed in the HVAC system 100 of FIG. 1. One or more air handler controllers (“AHCs”) 210 may be associated with the one or more air handlers 110 of FIG. 1. One or more integrated furnace controllers (“IFCs”) 220 may be associated with the one or more furnaces 120. One or more damper controller modules 215, also referred to as a zone controller module 215, may be associated with the one or more dampers 114 the interface the one or more dampers to the data bus 180. One or more AC controllers 225 may be associated with one or more evaporator coils 130 and one or more condenser coils 142 and compressors 140 of FIG. 1. The network 200 includes an active subnet controller (“aSC”) 230a and an inactive subnet controller (“iSC”) 230i. The aSC 230a is responsible for configuring and monitoring the system 100 and for implementation of heating, cooling, air quality, ventilation or any other functional algorithms therein. Two or more aSCs 230a may also be employed to divide the network 200 into subnetworks, or subnets, simplifying network configuration, communication and control. The iSC 230i is a subnet controller that does not actively control the network 200. In some embodiments, the iSC 230i listens to all messages passed over the data bus 180, and updates its internal memory to match that of the aSC 230a. In this manner, the iSC 230i may backup parameters stored by the aSC 230a, and may be used as an active subnet controller if the aSC 230a malfunctions. Typically there is only one aSC 230a in a subnet, but there may be multiple iSCs therein, or no iSC at all. Herein, where the distinction between an active or a passive SC is not germane the subnet controller is referred to generally as an SC 230.

A user interface (UI) 240 provides a means by which an operator may communicate with the remainder of the network 200. In an alternative embodiment, a user interface/gateway (UI/G) 250 provides a means by which a remote operator or remote equipment may communicate with the remainder of the network 200. Such a remote operator or equipment is referred to generally as a remote entity. A comfort sensor interface 260 may provide an interface between the data bus 180 and each of the one or more comfort sensors 160.

Each of the components 210, 220, 225, 230a, 230i, 240, 250, 260 may include a general interface device configured to interface to the bus 180, as described below. (For ease of description any of the networked components, e.g., the components 210, 220, 225, 230a, 230i, 240, 250, 260, may be referred to generally herein as a device 290. In other words, the device 290 of FIG. 2 is a proxy for any of a furnace, a heat pump, a subnet controller, etc, and that device's associated interface means.) The data bus 180 in some embodiments is implemented using the Bosch CAN (Controller Area Network) specification, revision 2, and may be synonymously referred to herein as a residential serial bus (RSBus) 180. The data bus 180 provides communication between or among the aforementioned elements of the network 200. It should be understood that the use of the term “residential” is nonlimiting; the network 200 may be employed in any premises whatsoever, fixed or mobile. In wireless embodiments, the data bus 180 may be implemented, e.g., using Bluetooth™ or a similar wireless standard.

Turning now to FIG. 3A, illustrated is a diagram 300 of a series of steps that occur in relation to a commissioning of the unit 155. The diagram 300 includes an enter state 301, a device commissioning state 303, and an exit state 305. The HVAC system 100 can be described as being partitioned into a plurality of subnets, each subnet controlled by its own active subnet controller 230a.

Device commissioning can generally be defined as setting operational parameters for a device in the network of the HVAC system, including its installation parameters. Generally, device commissioning 300 is used by the subnet controller 230 when it is active to: a) set operating “Installer Parameters” for a networked device, such as air handlers 110, (henceforth to be referred to collectively, for the sake of convenience, as the unit 155, although other devices are also contemplated), b) to load UI/Gs 240, 250 with names and settings of “Installer Parameters and Features” of the units 155, c) to configure replacement parts for the units 155, and d) to restore values of “Installer Parameters and Features” in units 155 if those “Parameters and Features” were lost due to memory corruption or any other event. Device commissioning is a process used in the HVAC system 100, either in a “configuration” mode or in a “verification” mode.

In the “configuration” mode, the unit 155 shares its information with the subnet controller 230a in an anticipation of being employable in the HVAC system 100, and an appropriate subnet. Generally, the commissioning process 300 provides a convenient way to change or restore functional parameters, both for the subnet controller 230a and the unit 155.

In both the “verification” mode and the “configuration” mode, the unit 155 is checked for memory errors or other configuration or programming errors. There are differences in device 260 behavior between the “configuration” mode and in the “verification” mode, to be detailed below.

The “subnet startup” mode programs the subnet controller 230 to be active. The “subnet startup” mode enables subnet communications, (i.e., communication within a subnet), and also deactivates a “link” sub-mode. A “link” mode may be generally defined as a mode that allows a number of subnets to work together on the same HVAC network 100, and that assigns subnet numbers for each subnet to allow this communication.

The “installer test” mode is employed when an installer installs and tests aspects and units 155 of the HVAC system 100. The “normal operations” mode is an ongoing operation of devices 260 of the HVAC system 100 in a normal use.

More specifically, the device commissioning state machine 300 can be employed with: a) the “configuration” mode, which is invoked when transitioning to the commissioning state from the “subnet startup mode” or “installer test” mode, or the “normal mode”, or b) a “verification” mode. The “verification” mode is invoked when transitioning to the commissioning state from the “subnet startup” mode.

The following describes an illustrative embodiment of a process of commissioning 300 the HVAC unit 155, first for a “configuration” mode, and then for a “verification” mode. The process of commissioning differs from a “subnet startup,” in that commissioning requires that the network configuration, including configuration and activation of subnet controllers 230, has already been completed before the commissioning 300 of the device 260 can start. Please note that there can be more than one subnet controller 230 on a subnet, but only subnet controller 230a is active at any one time.

In one embodiment, in order to enter into the state 320 of the process 300 in the “configuration” mode, the unit 155 receives either: a) an “aSC” (‘active subnet controller’) Device Assignment message”, having “Assigned State” bits set to “Commissioning”; or b) a receipt of an “aSC Change State” message, with “New aSC State” bits set to “Commissioning,” from the active subnet controller 230a. For both “configuration” and “verification” modes, an “aSC Device Assignment” message can be generally regarded as a message that assigns the unit 155 to a particular active subnet controller 230a. For both “configuration” and “verification” modes, an “aSC Change State” message can be generally regarded as a message that starts and ends employment of the commissioning state diagram 300 for the units 155 and all other devices on the subnet.

In the state 320 in the configuration mode, all units 155 respond to the “aSC Device Assignment” message with their respective “Device Status” messages, indicating that the units 155 are now in commissioning process 300 due to their response to this previous message. For both “configuration” and “verification” modes, the “Device Status” message can be generally defined as message that informs the active subnet controller 230a of what actions are being taken by the unit 155 at a given time.

However, alternatively, in other embodiments, in the state 320 in the “configuration” mode, if the units 155 are instead busy, as indicated by “aSC Acknowledge” bits of the “Device Status” message sent to the subnet controller 230a set as a “Control Busy,” the active subnet controller 230a will wait for the busy units 155 to clear their “Control Busy” bits before proceeding with further elements of the Commissioning 320 process. The units 155 then resend their “Device Status” messages as soon as they are no longer busy.

From this point on, all units 155 send their “Device Status” messages periodically and on any status change, both during and after the commissioning 300. If the unit 155 does not clear its “Control Busy” bits within a minute (indicating its control is no longer “busy”), the active subnet controller 230a sends an “Unresponsive Device2” alarm for each such unit 155. If in “configuration” mode, the active subnet controller 230a remains in the waiting mode indefinitely, until the unit 155 responds correctly, or the subnet is reset manually or after a timeout is reached. In “verification” mode the active subnet controller 230a proceeds further to exit the state.

In the “configuration” mode, each unit 155 remembers all of its optional sensors that are currently attached to it. Furthermore, each unit 155 may store a local copy in its non-volatile memory (“NVM”) of all of any other unit features that it is dependent on. A unit 155 feature can be generally defined as any datum that is fixed and cannot be changed by the installer, serviceman or the home owner. Changing of a “Feature” value normally involves reprogramming of the units 155 firmware.

In at least some embodiments, a feature is something that is fixed value that is hard-wired into a device. In other words, no installer or home owner can change it. Features are programmed into the unit 155 during a manufacturing or an assembly process. Features can be recovered in a home, during a Data non-volatile memory (“NVM”) recovery substate of Commissioning state only—the recovery substate happens automatically and without installer or user intervention. In a further embodiment, parameters can be changed by the installers only. In a yet further embodiment, the HVAC system 100 employs “variables”—those can be changed by the installers and also the home owners.

In some embodiments, a “Parameter List” is normally a Feature that contains a special list of specific parameters included in the unit 155. Parameter values can be changed, and their state can be changed also (from enabled to disabled and vice-versa), but their presence is set once and for all in a given firmware version. Therefore, a list of Parameters (not their values) is also fixed, and is thus treated as a “Feature.”

However, although elements of the “configuration” mode commissioning and “verification” mode commissioning are similar, when the active subnet controller 230a is in “verification” mode instead of in “configuration” mode, the active subnet controller 230a can exit commissioning 300 regardless of the value of the alarms of the units 155. However, alternatively, if the active subnet controller 230a is in “configuration” mode, the active subnet controller 230a will not exit from its commissioning state 300 for as long as at least one unit's 155 “aSC Acknowledge” flags are set to “Control Busy.” In one embodiment of the “verification” mode, the active subnet controller 230a timeouts the installation and resets the subnet to default parameters.

In the “verification” mode, assuming the unit 155 operates with a non-corrupted (original or restored copy) NVM, each unit 155 checks any of its attached sensors to see if they match with the parameters that were present in a most recent configuration of the unit 155. In some embodiments, alarms are generated by the unit 155 for missing or malfunctioning sensors as soon as the faulty condition is detected, to be employed by the user interfaces and gateways present on the subnet to notify the installer or homeowner of the encountered problem. The unexpected absence of certain sensors may inhibit the operation of the unit 155 or the subnet. This is normally manifested by the signaling of the appropriate Service Bits in the Device Status message used by the active subnet controller 230a, to determine the operational viability or health of the subnet's systems.

In some embodiments, the device commissioning process 300 then transitions into a state 305, and then ends, upon either: a) the last unit 155 receiving all of unit 155 parameters that it is dependent on, when in “verification” mode; or b) upon a request by a user, when in “configuration” mode. The active subnet controller 230a then proceeds to ensure that no subnet unit 155 has its “aSC Acknowledge” flag set to a “Control Busy” state. The “aSC Acknowledge” flag not being set indicates that all of a non-volatile memory of a given unit 155 had been written to with the necessary parameters. If no “Control Busy” state is detected, the active subnet controller 230a then issues the “aSC Change State” message, which forces the unit 155 from a commissioning state to a non-commissioning state, in either a “configuration” or a “verification” mode.

In some embodiments, when the unit 155 in the process 300 fails its NVM data integrity check in an “NVM Check State,” and the active subnet controller is unable to perform NVM Recovery, the unit 155 instead employs its default data stored in its non-volatile (Flash) memory and/or uses default calculations to initialize the data dependent on other devices in the system. The other device data to be used for commissioning could have been obtained in either the “verification” or “configuration” mode. For data or other parameters that were not transferred or generated as part of that commissioning 300 session, default values are used.

In one embodiment, upon a detection of a system configuration error, such as a missing device whose features or parameters the unit 155 depends upon, it uses the locally stored copy of the other device's features that it depends upon, and ignores any potential feature value conflicts. In another embodiment, the unit 155 uses the locally stored copy of other parameters of the unit 155 that it depends on and ignores any potential dependent parameter value conflicts. In other words, the unit 155 employs a first installed parameter as a template for a second installed parameter on a second device. In a third embodiment, the unit 155 will change its parameter or feature values only if explicitly instructed by the active subnet controller 230 or the UI/G 240, 250.

Turning now to FIG. 3B, illustrated is an HVAC device state machine 310 illustrated for a subnet, including the unit 155, in more detail. Solid lines indicate normal state transitions when the subnet is transitioning from one state to another state, green lines indicate a subroutine call and red lines, alternating dotted and dashed lines indicate unexpected yet valid transitions. All states other than state 326 represent device states, and the state 326 represents a message handling routine.

As is illustrated in the present embodiment, a reset state 312 of a subnet advances to a NVM CRC check 316 for a given device (such as unit 155). If the device fails the test, the device advances to a NVM programming 318. If the device passes, however, then in subnet startup 320, the device is assigned an address (Equipment Type number) and some features and parameters of the unit 155 may be shared with the subnet. Then, in substate 324, device commissioning as described in FIG. 3A occurs. This then leads to an installer test state 328. This, in turn, then leads to a link mode startup 330, as described above. Finally, then in a step 334, normal system operation occurs, although system can reset to state 312 or be brought to states 314 or 332 via diagnostic messages handled in a state 326.

In a further embodiment, during the NVM CRC check 316, the state machine 310 can advance to a NVM programming state 318. This can occur due to such factors as a failure of a non-volatile memory, or an initial programming of the NVM. In a yet further embodiment, each of these units 155 is programmed to deal with one form of a diagnostic message regarding system errors in a state 326, and from there to testing the device 160 itself in an OEM test mode 332.

Turning now to FIG. 3C, illustrated is a state flow diagram 340 for the active subnet controller 230a in relation to the unit 155. Generally, is the responsibility of the active subnet controller 230a to implement proper state transitions. The other units 155 follow the explicit direction of the aSC 230a for all valid transactions. These state diagrams are included to help ensure that a state of the unit 155 is the same as the subnet controller. The SC 230a is responsible for device synchronization. If the unit 155 is detected out of synch with the rest of the system, the aSC 230a, in some embodiments, immediately tries to bring the unit 155 to the current system state, if possible.

If an addressable unit 155 is detected in subnet startup 344, the subnet controller 230a applies asynchronous startup rules, which generally pertain to how many parameters are to be passed between device 155 and the active subnet controller 230a.

If an addressable unit 155 is detected in commissioning 345, installer test 346, link mode 347 or normal operation 348 substates, the unit 155, in some embodiments, is brought to the current state via a resend of an “aSC Change State” message, which involves transitioning from a first current aSC state to a second current aSC state.

In some embodiments, if a unit 155 is detected in OEM Test or Soft Disabled state, the unit 155 shall be reset by the active subnet controller 230a in a step 342. If a unit 155 is detected in “Hard Disabled” or “NVM Programming” state, the active subnet controller 230a assumes that it is not available on the subnet.

In a further embodiment, inactive subnet controllers 230i are required to keep the most up to date subnet and HVAC system configuration information. Inactive subnet controllers 230i listen to all UI/G and aSC messages and continuously update their non-volatile memory to attempt to be as consistent as possible with the settings stored in active subnet controller 230a.

### Programming and Configuration

Turning now to FIG. 4, illustrated is one embodiment of an RSBus Error Frame 400 that can be employed during a detection of an error condition of the units 155 over the RS bus 180 of the network 200, although over Error Frames are employable. In one embodiment, messages within the HVAC system 100 follow a format based on the “Bosch CAN2.0B standard” of the extended frame with a 29-bit identifier. A single message frame 400 includes the “Start of Frame bit,” (“SOF”) the “Arbitration Field,” the “Control Field,” the “Data Field,” the “CRC Field,” the “ACK Field” and the “End of Frame” Field. Each message frame starts with a dominant SOF bit (logical 0). All units 155 on the network ready to transmit messages may synchronize on the “start” bit generated by the unit 155 that initializes the transmission. Please note that in the following descriptions, “devices” and “units” may be used interchangeably.

### Corrupted Data Memory Handling

All units 155 coupled to the RSbus 180 (“RSbus devices”) typically can have rewritable non-volatile memory (“NVM”) to support the CAN protocol implementation. Following will be a description of actions that can take place when the non-volatile memory of the unit 155, and later to be discussed the 230a, is corrupted.

In one embodiment, all protocol related unit 155 settings stored in its own EEPROM in its own NVM memory, are also backed up by all subnet controllers 230, both active and inactive, on the subnet. In a further embodiment, units 155 can back up some application specific data in the subnet controllers 230. This can happen in form of special feature numbers that are part of the “Feature Manifest” in the “Commissioning” state 300, discussed above. In case of a NVM memory corruption, such as can occur as an electrically erasable programmable read-only memory (“EEPROM”) corruption within the unit 155, there are exemplary steps that are taken to ensure best possible data integrity, as will be discussed below.

As will be discussed below, in one embodiment, if the unit 155 has an internal copy of its own EEPROM settings to facilitate its memory recovery, the recovery of the back-up memory within the unit 155 is transparent to the behavior of the device in the system, which means that the unit 155 is able to work correctly (using the backed up correct values) before sending out a “Device Startup” message.

Generally, the actions to recover back-up data in a case of memory corruption are undertaken by the unit 155 in conjunction with the active subnet controller 230a. There are four exemplary failure modes that are typically possible:

a. The unit 155 loses its data but is able to recover them from an internal back-up. (Also discussed above.)

b. The unit 155 is unable to retrieve the values on its own. The active subnet controller 230a has previously stored correct values for the unit 155. The active subnet controller 230a can therefore relay the backed-up data to the unit 155.

c. The active subnet controller 230a has corrupted back-up data, and it therefore recovers uncorrupted back-up data from the unit 155.

d. If both the active subnet controller 230a and the device 110 are unable to retrieve previous data, the unit 155 shall revert to the default settings and update the active subnet controller 230a.

In one embodiment, the actions undertaken by the device and the active subnet controller 230a upon receiving a message from the device 155 indicating internally unrecoverable corruption of its parameters in the above scenarios are as follows:

a. In this case, there is no message indication of the problem and the unit 155 can attempt to recover the data from its internal back-up in a manner totally invisible to other addressable RSBus units 155, as discussed above. As discussed above, no indication is typically given to the active subnet controller 230a and control follows a “normal” mode of operation. If in “Verification Mode”, typically there is no need to perform full “Feature Manifest,” “Non-Communicating Check” and “Parameter Scan” in Commissioning by the active subnet controller 230a.

b. In this case, the unit 155 can start with its “DEVICE Startup message” sent on a selected Subnet (subnet “0”), using the default equipment type (“ET”), with the CF6 flag cleared. Generally, regarding the CF6 flag, within the device 110, CF6=0 if the unit 155 has failed the Data CRC check (all RSBus Data are invalid and are returned to default values)—as a result, CF0 flag is reset. Generally, the Control Serial Number is the serial number of the control board put inside of equipment. Equipment serial number can be the serial number of the furnace, or heat pump, or so on that contains the control board.

In one embodiment, the unit 155 responds to all subnet controller Coordinator messages with the same message until a new ET and Subnet ID are assigned to the unit 155. As long as the NVM data is not recovered within the unit 155, the CF6 flag of the unit 155 remains reset. The active subnet controller 230a can still recognize the device, using its “DD”, and can assign, in one embodiment, the same “ET” and “Subnet ID” to it as it had before. Immediately after recognizing that the unit 155 cannot retrieve its own NVM data, the unit 155 starts to recover all of its lost data, by retrieving their default values stored in the device flash. In the meantime, the active subnet controller 230a, upon entering “Commissioning” within the flows 310 or 340, shall reprogram the unit 155 with the data from its back-up. If so attempted, the unit 155 typically accepts the active subnet controller 230 data in place of its own default values.

c. This scenario typically only matters in “Verification” employment of the diagram 310, as in “configuration” mode the active subnet controller 230a can update its internal back-up data from all devices 155 anyway. Thus, in “Verification,” the active subnet controller initiates a full “Feature Manifest,” “Non-Communicating Check Scan” and “Parameter Scan” on the particular devices 155 that the active subnet controller 230a lost data from within its own memory, in place of the abbreviated version that normally happens during “Verification.”

d. In this case the unit 155 can retrieve its default values and, when in “Verification,” the active subnet controller shall proceed with the full “Feature Manifest,” “Non-Communicating Check Scan” and “Parameter Scan” on the particular devices that it lost data from, in place of the abbreviated version that normally happens during Verification.

### Data NVM Recovery State

The active subnet controller 230a enters this commissioning state substate typically only when the unit 155 has reported a loss of its internal NVM settings (e.g. corruption of the EEPROM cyclical redundancy check (“CRC”)) and the active subnet controller 230a contains a valid previously backed up version of the unit 155 data, wherein the unit 155 had been previously successfully configured in the presence of the active subnet controller 230a. This checking by the unit 155 can happen, for example, in the NVM CRC check of state 316 of flow 310.

In one embodiment, the unit 155 can be recognized by the active subnet controller 230a when its DD matches exactly the DD for the stored back-up data and its Equipment Type (“ET”) is of the same type as the Equipment Type stored in the active subnet controller 230.

In one embodiment, the active subnet controller 230 provides features and parameters in the exact same order as the device specified in its feature or parameter manifest, respectively. This is achieved by inquiring the device for its respective “Feature Manifest Features List”, its “Non-Communicating Scan Parameters List” and its “Parameter Scan Parameter List,” and using the order the units 155 provides, without inquiring about the Feature or Parameter values, to supply these respective Features or Parameters in the same exact order.

Upon entering the “Data NVM Recovery” sub state, the active subnet controller 230a performs full “Feature Scan” and full “Parameter Scan” in both “Configuration” and “Verification” Modes, as discussed regarding FIG. 3A, above. There are three possible cases here:

a) active subnet controller 230a has corrupted its own copies of several units 155 Parameters—only for that one device. In some embodiments, the active subnet controller 230 keeps separate CRCs for each device data;

b) active subnet controller 230a has its entire EEPROM corrupted; and

c) the unit 155 has its EEPROM corrupted.

The following actions can be taken, after receiving the message indication of NVM data corruption from the unit 155:

a) the active subnet controller 230a forces this specific unit 155 to go through “Full Feature Manifest” and “Full Parameter Scan”, other devices are unaffected;

b) the active subnet controller 230a forces all units 155 to go through “Full Feature Manifest” and “Full Parameter Scan;”

c) the active subnet controller 230a forces this specific unit 155 to go through “Full Feature Manifest” and “Full Parameter Scan,” other devices 155 are unaffected.

### Replacement Check State

In one embodiment, the network 200 automatically commissions replacement units 155 in a place, such as a customer home. When in “configuration” mode within the diagram 340, and the active subnet controller 230a determines that the unit 155 is missing and that a physically different, yet compatible unit 155 was put into the subnet with a “CF5” flag set, it prompts a user, via the U/IG 250 (which, for the duration of the description, can also alternatively mean the user interface 240), to decide whether the new unit 155 should have the parameters of the missing unit 155 copied into it. Generally, when the CF5 flag is set, it is indicative of a replacement part scenario. If affirmed by the user, and the parameters are copied into the unit 155 into it, the active subnet controller 230a proceeds to also store in the new unit 155, the relevant equipment-related features such as “Equipment Serial Number,” “Equipment Part Number” and its capacity as well as previously set “Parameter” values.

In one embodiment, the active subnet controller 230a checks the device compatibility by requesting the unit's 155 “Compatible Devices List” feature and checking the part numbers contained within it against the “Control Part Number” of the missing control. If there are any problems with programming any specific features or parameters of the new unit 155, the active subnet controller 230a prompts the user as to this issue, yet still attempts to program the remaining information into the unit 155.

Turning now to FIG. 4, illustrated is an exemplary method flow 400 of active subnet controller 230a behavior for identifying a replacement unit 155 and also for commissioning the replacement unit 155. In a step 401, the active subnet controller receives a new “DD.” In a step 403, the active controller 230a subnet determines whether the device 155 is entering a configuration state. If not, a step 405 is entered, and the new unit 155 is soft-disabled, and the flow ends.

However, in one embodiment, if the unit 155 is entering into a configuration state, it is then determined by the active subnet controller 230a if there are at least two of the same type units 155 present. If not, the flow 400 advances to a step 413. However, if two devices are present, the flow 500 advances to a step 409. In a step 409, it is determined if enough equipment types are available. In other words, it is determined whether the active subnet controller 230a can support this many types of devices. If not, the flow advances to step 511, and a too many devices of same type alarm is set off, and the flow ends. However, if a plurality of units 155 can be supported, that in step 413, the devices is accepted into the subnet.

Next, in step 415, it is determined whether a networked HVAC devices “ET” is in a same range as a missing device. If it is, then in a step 417, the new unit 155 is assigned with the missing devices ET, and the flow advances to a step 421. However, if not in the same range, then the new device is assigned with the next lowest (or highest if the device is a gateway), and advances to a step 431.

In step 421, the commissioning stage of the unit 155 begins. In step 421, it is determined whether the CF5 flag of the device 155 is set. When the CF5 flag is zero, and the DD does not match, this means that new equipment is added to the subnet and it should not be reprogrammed, hence no replacement scenario is triggered in “commissioning.” If the “CF5” flag is not set, the flow 400 advances again to step 431, otherwise the flow advances into a step 423.

In step 423, in one embodiment, it is determined whether the new part is a compatible replacement for the old part. If not, the flow 400 again advances to step 431. If yes, the flow 400 advances to a step 425. In step 425, a choice is displayed to a user, that shows the both the active subnet controller 230a old back-up copy and the new serial and part numbers. In a step 427, it is determined whether the user selects the old control serial and part numbers from the old back-up copy provided by the active subnet controllers 230a, or the new numbers. If the user does not employ the old values provided by the active subnet controller 230a, the flow 500 advances to step 431. If yes, the flow advances to step 429. In step 531, the newly found part is treated as a new device.

However, in a step 429, the active subnet controller 230a copies the back-up serial and part numbers into the device 155, as well as other pertinent information. In a step 433, the active subnet controller 230a keeps the old unit 155 settings until an active subnet controller 230a “Change State” is invoked into an “Installer Test” mode. Both steps 431 and 433 advance to step 435, wherein the replacement check ends.

Turning now to FIG. 5A, illustrated is a high level block diagram of an embodiment of a subnet 540 with a non-volatile memory back-up included within a subnet controller 542 of the HVAC network 200. The subnet controller 542 includes a back-up memory for devices 544 and a memory conveyor 545. The back-up data can be conveyed over the RSbus 180 to a HVAC device 546, 548, each have a NVM memory 547, 549, respectively.

Generally, in the system 540, a back-up system configuration and other information for the subnet 540 is stored into the subnet controller 542, which can be active or inactive. The back-up data includes various setup data (which is typically non-volatile data) for each device 546, 548 that has data that is typically modified or received by the subnet controller 230, such as during the commissioning 300 process.

The back-up of data between the subnet controller 542 and the devices 546, 538 can occur in at least two scenarios: a) the device 546, and/or 548 is replaced with a same or equivalent device, wherein an equivalent device can be generally defined as having compatible parameters to be modified by the subnet controller, such as discussed regarding flow 400, above; and b) there is non-volatile data corruption within the device 546, 548 or the subnet controller 542. The subnet controller 230 can be an active or inactive subnet controller 230.

Turning now to FIG. 5B, illustrated is an embodiment of flow for a method 550 for transferring back-up information between a subnet controller and a coupled device in a subnet of the HVAC network 200.

After a start step 552, in one embodiment, in a step 555, back-up information is stored for the unit 155 in a coupled subnet controller of a subnet of the HVAC system 100. In a step 560, it is determined whether a memory corruption, correlating to the non-volatile information for the device, has occurred in the subnet controller 230. If not, the method 550 advances to a step 570. If yes, the method 550 advances to step 565.

In a step 565, it is determined whether a memory corruption has occurred in the device 155. If no corruption has occurred, the method 550 conveys the back up information from the device 155 to the subnet controller 230, and the steps stop in step 595. If corruption has occurred, the device restores its own value from back-up and then conveys this value to the subnet controller 230, and the steps stop in step 595.

In a step 580, it is determined with the unit 155 has been replaced by a unit of a compatible type. If yes, back-up information is conveyed to the device in a step 590, and the method 500 ends in the stop step 595. If not, however, in a step 580, it is determined whether a memory corruption has occurred in the unit 155. If no, the method 550 stops in a step 595. If yes, again in the step 590, back-up information is conveyed to the device 155, and the steps stop in the step 595.

Turning now to FIG. 6, illustrated is a state diagram 600 illustrating that, in some embodiments, a UI/G 601 can flash program memory of multiple HVAC devices/addressable units 602, 603. In one embodiment, up to 32 HVAC devices' 155 application code can be programmed over the bus 180. This diagram is generally directed towards NVM programming. NVM programming serves to update the program and happens from the UI/G, and the active subnet controller 230a is typically not involved.

Typically, RSBus units 155 are required have a flash memory, which offer more functionality than one time-programmable or masked memory. Flashing can be generally defined as programming a non-volatile memory that can, nonetheless, be written over with a late flash. Furthermore, the units 155 are typically able to be flashed over the RSBus 180 in an installation factory, and the units 155 typically have the ability to be flashed over the RSBus 180 in the field, after they were put on the market. These two scenarios are different, as they affect different areas of the flash memory space.

In one embodiment, flashable space can be divided into at least three segments that contain a separate code and two data areas—supplier and manufacturer data areas, as shown in FIG. 7A, to be discussed below: “Example HVAC Device Memory Structure.”

During the build of the code area in its factory, a supplier typically flashes the code area with the most up to date version of the code, as well as the first one of the data areas—the supplier data area, which includes data only relevant to the control, such as “Device Designator,” “Control Part” and “Serial Number,” etc. leaving the installer data area, such as manufacturer data, set to all zeros. If a controller board is then used as a component of an installer built product, all installer equipment related information (including the Serial and Part Number of the equipment the controller board is put in) needs to be flashed into the installer data area at an installation plant. It is typically up to the supplier to choose to the right technology to store the two data areas—they can either be stored in the microcontroller flash memory, or possible in an on- or off-board EEPROM.

Turning now to FIG. 6A, illustrated is an exemplary flow 605 for programming a non-volatile memory in an HVAC device/addressable unit. NVM flashing flow 605 supports flashing of application/firmware code in units 155 over the RSBus 180. The unit 155 can be flashed by the UIG 250 or a computer connected to RSBus 180 through the gateway 250.

Generally, the NVM flashing flow 605 uses “class 6” diagnostic messages to enter and exit the “NVM Bootloader” in a step 620, to be discussed below. Generally, Class 1 messages to/from UI/G, class 3—broadcast, class 5 to/from SC and class 6 diagnostic (does not require valid ET or SID)—to/from UI/G.

The NVM flashing flow 605 can use “class 1” messages for flashing target devices. “Class 6” messages use Device Designator bits to address each specific device, so that even un-configured or disabled units 155 send and receive class 6 diagnostic messages. Each unit 155 enters boot loader mode 625 for flashing application code in its non-volatile memory. The target device 155 can enter boot loader in the following ways:

1. In one embodiment, upon reset 607, each device/addressable unit can calculate the checksum of the application code in a step 610. If there is a mismatch between the stored checksum and the calculated checksum, the target unit 155 enters boot loader mode in a step 625. The device shall broadcast a Device Request “UI/G Info On CRC Error” message every one minute until the user interface/gateway 250 responds by sending an “UI/G Request Device Enter Bootloader Mode” message. The unit 155 sends this message with connection status in connection initialization mode. A “Subnet ID” value is incremented for every message sent starting from 0. It is set to 0 after the maximum value of Subnet ID is reached (i.e. 3). The “CRC Error on Reset” bit is then set to 1. The UIG 250 ignores the connection number field if “CRC Error on Reset” bit is set to 1.

2. In one embodiment, the UI/G 250 can command the unit 155 to enter boot loader mode using command and response messages for connection establishment and password authentication. The target addressable unit 155 then completes its existing operation and then enter Bootloader mode 625. After bootloader mode 625, the device then enters either the NVM application programming mode 630 or the NVM feature programming mode 635. However, if the CRC check passes for CRC, the unit 155 enters into the application mode, and awaits the “Class 6” diagnostic messages in state 620, before entering into state 625.

Generally, the user interface/gateway 250 maintains device information for all the current devices it is trying to flash. For each unit 155 it will record information such as:

a. Device Designator;

b. Connection status;

c. Connection number; and

d. Cycle number.

In one embodiment, the UI/G 250 keeps a record of the device's total size of Flash available for application code, expressed in bytes, and in some further embodiments, also size of the available RAM. This information is retrieved from the unit 155 using command and response “Class 6” messages prior to actual flashing, such as illustrated in state 620. The UI/G 250 can verify that there is sufficient flash size on the units 155 prior to attempting to enter the bootloader mode 625.

In one embodiment, the UI/G 250 establishes a connection and assigns a unique connection number to each device 155. The command and response messages responsible for NVM Flashing within units 155 can follow 2 rules:

A. UI/G 250 or the target addressable unit 155 will wait for a maximum of 3 seconds to get a response.

B. The UI/G 250 or the target device 155 will update its response (to a command) in a CAN transmit buffer of the UIG 250 or the device 155 within 100 milliseconds.

Connection establishment can be performed by exchanging messages between UIG 250 and the target device 230 as described below, as also referenced the FIG. 6A:

1. In one embodiment, the UI/G 250 sends a bootloader entry command to the target device 155 (Message: “UI/G Request Device Enter Bootloader Mode”). The UI/G 250 updates the connection status field in this message to connection initialization mode. In one embodiment, the unit 155 does not accept any further bootloader entry commands until the unit 155 connection status is reset to “no connection”. The UI/G 250 Device Designator and the target device's 110 Subnet ID are provided to the target units 155 by the UI/G 250 in this message. The UI/G 250 can assign a unique connection number to the target units 155.

2. In one embodiment, the unit 155 authenticates the UI/G 250 by requesting it to send password (Message: “Device Request Password”). The unit 155 also provides the available size of NVM memory, required for programming Application code.

3. In one embodiment, the UI/G 250 responds by sending a password string in the message data (Message: “UI/G Send Password”). After validating the password, the unit 155 stops executing its current application, and will instead start executing Boot loader code. The password string can be encrypted using the encryption/decryption algorithm. If the password does not match, the device 155 typically responds with “Device UI/G Bootloader Status” message in NVM Programming mode.

In one embodiment, if the log-in process into the NVM bootloader was initiated as a result of NVM CRC Check failure, such as in the step 610, the unit 155 then proceeds to periodically resend the “Device UI/G Bootloader Status” messages. If the log-in process was initiated from the application, such as in step 615, the device then exits NVM Programming state 630, goes back to the interrupted application and resumes normal operation.

4. In one embodiment, the unit 155 acknowledges the UIG 250 by updating the connection status to connection established mode (Message: “Device Acknowledge Bootloader Mode”). The unit 155 estimates a maximum allowable data it can store in its RAM buffer before flashing it to NVM. The unit 155 provides its RAM buffer size (Packet size) in this message.

Steps to disconnect an established connection in one or various embodiments:

1. Once the flashing is complete, the UI/G 250 sends a command to exit boot loader mode (Message: “UI/G Request Device Exit Bootloader”).

2. The connection between the target device 155 and the UIG 250 is disconnected if the UI/G 250 request to exit boot loader mode. The target unit 155 sends an acknowledgement and performs a self-reset (Message: “Device Acknowledge UI/G Exit Bootloader”).

Turning now to FIG. 6B, illustrated is one embodiment of a code segmentation to be used when programming or reprogramming a Non-Volatile Memory of a device. Generally, the UIG 250 and the target unit 155 follow a segmented message transfer protocol to send application code over the RSBus network 180. The UI/G 250 divides application code in to smaller packets and each packet will be further divided into messages. The Packet Size is defined by the target unit 155 and is sent to the UI/G 250 using a “Device Acknowledge Bootloader Mode” message. In each cycle, one packet will be transferred and the cycle count will be incremented by one.

FIG. 6B illustrates shows an embodiment of a segmentation procedure 640 for flashing an application code 645 in units 155. In one embodiment, the application code 645 can be divided in to 65536 packets. In one embodiment, the maximum size of each packet can be up to 4093 bytes (as 2 bytes are required to define the Packet Size). In one embodiment, the segmented message transfer protocol supports flashing of 255.812 Megabytes of application code 645 in to the target unit 155.

In one embodiment, the UI/G 250 uses the “UI/G Send Segmented NVM Flashing Data Transfer Protocol” message to send Packets to the unit 155. After each Transfer Protocol session (i.e. each cycle) the unit 155 sends the “Device UI/G Bootloader Status” message, indicating a status of the received packet. Upon receipt of an error, the UI/G 250 takes corrective action immediately after the end of TP session. Some Exemplary “Flashing Errors and Status Values” are described as below:

1=Cycle transfer complete;

2=Incorrect password;

3=Wrong connection number;

4=Device connection status already in initialization mode or connection established mode;

5=Device connection timed out;

6=Wrong application target;

7=Wrong cycle number;

8=Insufficient application memory size;

9=Wrong connection status;

10=NVM flashing complete;

129=Wrong TP sequence number; and

130=CRC error after NVM flashing.

In a case of a communication timeout with the UIG 250, the unit 155 can send its “Device UI/G Bootloader Status” message as soon as the time-out occurs, and then every one minute after that until a new attempt to establish a session is undertaken by the UI/G 250.

In one embodiment, once all the packets are written to its own NVM, the target unit 155 can perform a CRC check on the flashed application code. The target device/addressable unit 155 can send an acknowledgement with the Error and Status value equal to NVM flashing complete. In a further embodiment, the boot loader may copy NVM flashing subroutines/functions in RAM. Each unit 155 may reset after flashing is complete; and when it passes the CRC check, it shall start running the application code.

Turning now to FIGS. 6C1 and 6C2, illustrated are exemplary “UIG and Target Device Flashing Initialization Sequence” and a “UIG and Target Device Application Code Sequence”, respectively. Generally, while in the Bootloader Mode, maintaining of a time stamp and alarm logging are optional, as they might be limited by the amount of memory available. In one embodiment, the alarms are still issued as specified, with their time stamp value set to 0 if no time clock is available. Similarly, if no ET was set for the device, the default Equipment Type value is used—this is normally its lowest possible value for this device type.

In one embodiment, to communicate with the UI/G 250 while in the state, the device uses the UIID obtained from the UI/G messages addressed to it. In one embodiment, the “Equipment Type” for each UIG 250 is its UIID offset by +0x70 (ET=UIID+0x70). For the initial device messages that are not solicited by the UI/G 250, the device assumes the default Gateway UIID value of 15 (i.e. ET=0x7F).

In some embodiments, for all point-to-point “class 1” and “class 5” messages within the Bootloader the unit 155 uses the same ET number. The ET is the arithmetic sum of a fixed number and the assigned Connection number. While sending the alarms, the device 155 uses its default (lowest possible value) ET number unless previously assigned otherwise (when entering the state from other than failed CRC Check).

Turning now to FIG. 7A, illustrated is an exemplary HVAC device memory structure 700 for use in unit 155 of the HVAC network 200 of the HVAC system 100. Generally, the memory structure 700 allows for an efficient, non-volatile memory management in embedded HVAC devices that can be either initially programmed or restored. In a further embodiment, the structure 700 allows for it firmware to be updated without affecting data stored in previous revisions in the firmware.

In one embodiment, the structure 700 includes a flash memory 703 to retain program code and constant data. The structure 700 also includes an EEPROM memory 704 to store all application data. In the illustrated embodiment, the structure 700 employs a Harvard architecture microprocessor (or microcontroller.) In an alternative embodiment, for a von Neumann type microprocessor (or microcontroller), a code memory space 705 and a data memory space 715 are combined.

In some embodiments, proprietary information is stored into a memory area 725, such as a page, during equipment assembly process in a manufacturing plant and includes factory programmable features. This data is stored in the flash memory 703, so that writing application data 730 within the EEPROM data memory 704 does not erase these values. In one embodiment, a difference between data stored in the application data 730 and data stored in the data memory space 715 of flash memory 703 is that data memory space 703 is data used by the program to set parameters for the device 155, whereas the memory 704 is used for to store this program and may additionally include manufacturer type information, i.e., information that exists in the device 155 before it is installed.

In a further embodiment, a bootloader memory area 710 contains a protected bootloader program that can not be flashed. The protected area of the memory 703 can further include a protected space, a protected page 720. The protected space 720 can include the DD, which can be based off of the unique 32 bit MAC address value, a control serial number, a control part number, and anything else explicitly requested to be stored in a device 155 by a supplier specification.

For units 155 that are to be assembled at a factory, the manufacturer data space 725, which can be a protected data page, contains information that is to be programmed into the memory system 700, such as a unit model number and an unit serial number that the unit 155 is a part of. Generally, the supplier data page 725 is programmed during a factory test by the assembler when a replacement part is put into an existing unit by an assembler at a factory or in the field by an installer. In a further embodiment, all manufacturer-programmed features are stored as application data 730 in the area 704, separate from the factory programmed features. The default parameter values are also permanently stored in the NVM, in section 715 (for von Neumann device architectures memory spaces 705 and 715 are one and the same.) The current values of these manufacturer parameters are typically stored in EEPROM.

In one embodiment, if firmware were to be upgraded in the structure 700, the new firmware version reads the previous NVM 715 values, and can add new values to these features, without destroying existing data. In some embodiments, all device features stored in the flash memory 703 are to protected, which is achieved by storing them in their own memory flash areas.

Turning now to FIG. 7B, illustrated is an exemplary method 730 for flashing data into a device having an embodiment of the device memory structure. After a start step 732, in a step 735, a code area is flashed in an HVAC device/addressable unit by a supplier. In a step 740, a first data area in an HVAC device is flashed by the control board supplier. In a step 745, a second data area is flashed during final equipment assembly of the HVAC device. The method 730 stops in a step 747.

In some embodiments, all units 155 have flash memories that are flashable with employment of the method 640. Furthermore, the units 155 are flashed over the RSBus 180 in a assembly factory, and the units 155 also further have an ability to be flashed over the RSBus 180 in the field, after they are put on market, and can also be performed through the UI/G 250 over the Internet, as can other interactions with the HVAC system 100. The flashable memory space is divided into at least three segments that contain a separate code and two data areas—supplier and equipment manufacturer (such as manufacturer data areas), as discussed above regarding FIG. 7A.

In one embodiment, during the build in its factory, the supplier flashes the code area with a most up to data version of the code, such as in step 735, as well as the first one of the data areas, such as in step 740. In one embodiment, the supplier data includes the device designator, a control part, and a serial number, and leaves the installer data area all zeros. If the control part information is used as a component of an installer-built product, the supplier equipment-related information (including the serial and part number of the equipment the controller is programmed in) is flashed in a step 745 into the equipment manufacturer data area, at the equipment manufacturer's factory or in the field. In a further embodiment, the supplier can choose a technology to store the various data areas—they can either be stored in a microcontroller flash memory, or in an alternative, in an on-or-off board EEPROM.

Turning now to FIG. 7C, illustrated is an exemplary flashing of a memory area of a memory device of a unit 155, illustrated in more detail.

Turning now to FIG. 7C, illustrated is an exemplary flow of a method 750 for loading parameters into a protected memory of the structure 700 of the unit 155. After a start step 755, in a step 760, bootloader code is stored into a protected flash memory of an HVAC device. In a step 765, a device designator is stored into the protected flash memory of the HVAC device. In a step 770, a control serial number is stored in the protected flash memory of the HVAC device. In a step 775, a control part number is stored into the protected flash memory of the HVAC device.

In a step 780, other explicitly requested device information is stored into the protected flash memory of the HVAC device. In a step 785, application data is stored into a separate EEPROM memory of the HVAC device. In a step 790, a bootloader code is invoked to flash code into the HVAC device. The method stops in a step 795.

Turning now to FIG. 8A, illustrated is an exemplary method 800 for reading an RFID that is coupled to control board of a HVAC device/addressable unit. In some embodiments, HVAC networks 200 include control boards that can be changed out if they are faulty. When the boards are changed out and replaced, an installer sets jumpers or flips switches to configure a new board to work properly. Employment of RFID tags can help with this, as this information, received by an RFID reader from an RFID tag, can be used by the installer to install the board into an HVAC device.

First, an RFID tag may be installed close to where the control board will be installed within the HVAC device. The control board is equipped with an RFID reader. When power is applied to the board, it sends out a radio-frequency that powers the RFID tag, and the RFID will then transmit setting information that are associated with the unit to the control board. This information will then be used by the control board or the installer to install or otherwise configure the board. In some embodiments, this can allow one type of control board to be used with multiple type units, as the control board configures itself based upon the information it receives from the RFID. The RFID does not need batteries, and is only powered when the control board requests the unit information.

In the exemplary method 800, after a start step 805, an RFID device is installed in a HVAC device in a step 810. In a step 815, an HVAC control board for a device that includes an RFID reader is installed. In a step 820, the board is powered up, and the RFID reader also is powered up. In a step 825, the RFID reader reads the RFID information transmitted by the RFID tag within the HVAC device. In a step 830, the method stops. In a further embodiment of the method 800, the board employs the information read by the RFID reader to configure itself.

Turning now to FIG. 8B, illustrated is a system 850 including a HVAC device 855, an RFID tag 860, an installed control board 865 for the HVAC device 855, and an RFID reader 870. In one embodiment, when the control board 865 is installed in the HVAC device 855, or is otherwise interested in device 855 information, the RFID reader 870, installed within the controller board, reads the RFID tag 860, and this information is conveyed to the control board 870 to be used for commissioning, which can include as initial set-up or replacement.

Those skilled in the art to which this application relates will appreciate that other and further additions, deletions, substitutions and modifications may be made to the described embodiments.

What is claimed is:

1. A method for creating a memory of an HVAC device, comprising:
storing a bootloader into a first protected memory of said HVAC device;
storing a device designator into a second protected memory of said HVAC device;
storing a control serial number into a third protected memory of said HVAC device;
storing a control part number into a fourth protected memory of said HVAC device; and
storing an application data into a separate application memory of said HVAC device.

2. The method of claim 1, further comprising invoking said bootloader code to flash information into said HVAC device.

3. The method of claim 1, wherein said second, third and fourth memory are contained within a same physical memory.

4. The method of claim 1, further comprising storing other explicitly requested device information into a fifth protected memory of said HVAC device.

5. The method of claim 1, wherein said application memory is an EEPROM.

6. The method of claim 1, wherein said device includes an addressable unit.

7. A memory for use for flashing a HVAC device, comprising:
a protected bootloader area;
a protected data memory area configured to contain protected data;
a protected supplier data memory area configured to contain factory programmable features; and
a separate application data page configured to contain protected application data,
wherein said memory areas and said data page are contained within said HVAC device.

8. The memory of claim 7, wherein said protected data memory area contains at least one of:
a device designator,
a control number, and
a control part number.

9. The memory of claim 7, wherein said protected bootloader memory, said protected data memory, and said protected supplier data memory all are stored in same flash memory.

10. The memory of claim 7, wherein said application data is stored in an EEPROM data memory.

11. The memory of claim 7, wherein said first protected memory area is a protected memory page.

12. A method for flashing a memory of a HVAC device, comprising:
flashing a code area by a supplier in an HVAC device,
flashing a first data area by the supplier in the HVAC device, and
flashing a second data area by an installer in the HVAC device.

13. The method of claim 12, wherein said first data area is a protected area and includes a protected data memory, wherein said protected data memory area contains at least one of:
a device designator,
a control number, and
a control part number.

14. The memory of claim 12, wherein said first protected memory area is a protected memory page

15. The method of claim 12, further comprising invoking a bootloader code to flash information into said HVAC device.

16. The method of claim 12, further comprising storing other explicitly requested device information into a third memory of said HVAC device, wherein said memory area is a protected area.

17. The method of claim 12, wherein said HVAC device includes an addressable unit.

18. The memory of claim 12, wherein an application data is stored in an EEPROM data memory of said HVAC device.

19. The method of claim 12, further comprising:
installing an RFID in said HVAC device;
installing a board for said HVAC device in said HVAC device, said board including an RFID reader;
powering up said board configured to include said RFID reader; and
reading HVAC device information at the board by said RFID reader.

20. The method of claim 35, wherein said powering up of said board occurs during a commissioning of said HVAC device.
